(19) United States
(12) Patent Application Publication
(10) Pub. No.: US 2026/0340674 A1
(43) Pub. Date: Oct. 29, 2026

(54) PREDICTIVE CUSTOMER CHURN PROTECTION

(71) Applicant: Starz Entertainment, LLP, Santa Monica, CA (US)

(72) Inventors: Michael BAGALMAN, New York, NY (US); Ali ERKURT, Santa Monica, CA (US); Nathan BLAIR, Santa Monica, CA (US); Elis VAYNA, Santa Monica, CA (US)

(21) Appl. No.: 19/193,624

(22) Filed: Apr. 29, 2025

(51) Int. Cl. G06Q 30/0207; G06N 20/20; G06Q 10/04

(52) U.S. Cl. CPC G06Q 30/0207; G06N 20/20; G06Q 10/04

(57) ABSTRACT

Systems, methods, apparatuses, and computer program products for generating, monitoring, and managing customer retention offers. A method may include receiving, by a computing device, from at least one application, customer data associated with at least one customer; determining, by the computing device, that the customer data is below at least one threshold; performing, by the computing device, a logistic regression on the customer data; receiving, by the computing device, additional customer data, wherein the customer data is at least the at least one threshold; performing, by the computing device, a gradient boosting data modeling procedure on the additional customer data; and generating, by the computing device, at least one customer retention offer.

### TECHNICAL FIELD

Some example embodiments may generally relate to customer loyalty and retention programs. For example, certain example embodiments may relate to systems and/or methods for generating, monitoring, and managing customer retention offers.

### BACKGROUND

Customer retention programs can include techniques designed to encourage existing customers engaged with a business, especially a subscription service, to continue the business relationship, such as by suggesting repeat purchases, promoting loyalty programs, and fostering long-term relationships. Such strategies are critical to increasing customer lifetime value (CLV) and decreasing customer churn (i.e., the rate at which customers stop doing business with a company).

### SUMMARY

In accordance with certain example embodiments, an apparatus may include at least one processor and at least one memory storing instructions that, when executed by the at least one processor, cause the apparatus at least to receive, from at least one application, customer data associated with at least one customer. The at least one memory and instructions, when executed by the at least one processor, may further cause the apparatus at least to determine that the customer data is below at least one threshold. The at least one memory and instructions, when executed by the at least one processor, may further cause the apparatus at least to perform a logistic regression on the customer data. The at least one memory and instructions, when executed by the at least one processor, may further cause the apparatus at least to receive additional customer data, wherein the customer data is at least the at least one threshold. The at least one memory and instructions, when executed by the at least one processor, may further cause the apparatus at least to perform a gradient boosting data modeling procedure on the additional customer data. The at least one memory and instructions, when executed by the at least one processor, may further cause the apparatus at least to generate at least one customer retention offer.

In accordance with some example embodiments, a method may include receiving, by a computing device, from at least one application, customer data associated with at least one customer. The method may further include determining, by the computing device, that the customer data is below at least one threshold. The method may further include performing, by the computing device, a logistic regression on the customer data. The method may further include receiving, by the computing device, additional customer data, wherein the customer data is at least the at least one threshold. The method may further include performing, by the computing device, a gradient boosting data modeling procedure on the additional customer data. The method may further include generating, by the computing device, at least one customer retention offer.

In accordance with certain example embodiments, an apparatus may include means for receiving, from at least one application, customer data associated with at least one customer. The apparatus may further include means for determining that the customer data is below at least one threshold. The apparatus may further include means for performing a logistic regression on the customer data. The apparatus may further include means for receiving additional customer data, wherein the customer data is at least the at least one threshold. The apparatus may further include means for performing a gradient boosting data modeling procedure on the additional customer data. The apparatus may further include means for generating at least one customer retention offer.

In accordance with various example embodiments, a non-transitory computer readable medium may include program instructions that, when executed by an apparatus, cause the apparatus to perform at least a method. The method may include receiving, from at least one application, customer data associated with at least one customer. The method may further include determining that the customer data is below at least one threshold. The method may further include performing a logistic regression on the customer data. The method may further include receiving additional customer data, wherein the customer data is at least the at least one threshold. The method may further include performing a gradient boosting data modeling procedure on the additional customer data. The method may further include generating at least one customer retention offer.

In accordance with some example embodiments, a computer program product may perform a method. The method may include receiving, from at least one application, customer data associated with at least one customer. The method may further include determining that the customer data is below at least one threshold. The method may further include performing a logistic regression on the customer data. The method may further include receiving additional customer data, wherein the customer data is at least the at least one threshold. The method may further include performing a gradient boosting data modeling procedure on the additional customer data. The method may further include generating at least one customer retention offer.

In accordance with various example embodiments, an apparatus may include receiving circuitry configured to perform receiving, from at least one application, customer data associated with at least one customer. The apparatus may further include determining circuitry configured to perform determining that the customer data is below at least one threshold. The apparatus may further include performing circuitry configured to perform performing a logistic regression on the customer data. The apparatus may further include receiving circuitry configured to perform receiving additional customer data, wherein the customer data is at least the at least one threshold. The apparatus may further include performing circuitry configured to perform performing a gradient boosting data modeling procedure on the additional customer data. The apparatus may further include generating circuitry configured to perform generating at least one customer retention offer.

### BRIEF DESCRIPTION OF THE DRAWINGS

For a proper understanding of example embodiments, reference should be made to the accompanying drawings, wherein:

FIG. 1 illustrates an example of an offer management system (OMACS) according to certain example embodiments;

FIG. 2 illustrates an example of offers corresponding with deals or incentives according to various example embodiments;

FIG. 3 illustrates an example of a signaling diagram according to certain example embodiments;

FIG. 4 illustrates an example system diagram; and

FIG. 5 illustrates an example of various network devices according to some example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for generating, monitoring, and managing customer retention offers is not intended to limit the scope of certain example embodiments, but is instead representative of selected example embodiments.

As mentioned above, customer loyalty and retention programs can include customer retention offers that are designed to encourage existing customers to continue a business relationship (e.g., subscription service), rather than cancelling the subscription service and/or switching to a competing subscription service. Such customer retention programs should be designed to consider individual customer needs, beginning with an analysis of customer data to identify parameters such as individual customer behavior, purchase history, preferences, and/or customer demographics. This can assist the merchant in identifying high-value customers, potential customers that may cancel the service (i.e., “churn”), and/or how to discourage customer churn. By analyzing and classifying customers, merchants can generate retention strategies that are personalized for a particular customer, benefiting both the customer (e.g., continuing to receive a valuable service) and the merchant (e.g., continuing to receive revenues).

CLV is a data-driven metric that provides an estimate of the total revenue a particular customer spends with a merchant during the life of their business relationship. More particularly, a historic CLV may define revenue already received by a merchant from a particular customer, while a predicted CLV may estimate how much revenue a merchant should expect to receive from a particular customer. As an example, historic CLV may be calculated based on the average length of the relationship between the customer and merchant, as well as the revenue received from the customer.

Customer churn rate may be calculated as

$$churn rate = ( \frac{number of customer lost within a time period}{total number of current customers at beginning of period} ) \cdot 100 ,$$

resulting in the percentage of customers that ended their business relationship with the merchant within the period of time. For example, if a merchant began January with 10,000 customers, and ended January with 9,000 customers, the churn rate would be calculated as 10%.

However, as noted above, while customer data such as customer behavior and purchase history can be helpful to generate customer retention offers, this may be difficult to perform when customer data of a particular customer is limited. For example, customer data may be limited when a customer is relatively new, has not engaged with the merchant recently, and/or had minimal engagement with the merchant during the business relationship (e.g., six-month streaming subscriber, but watched minimal content). While some simple techniques exist to generate customer retention offers despite limited customer data, such techniques may result in ineffective or unpersuasive customer retention offers due to being non-personalized. Moreover, there are currently no techniques to transition customers between an analysis for customers with insufficient data and customers with sufficient data.

Certain example embodiments described herein may have various benefits and/or advantages to overcome the disadvantages described above. For example, certain example embodiments may reduce or eliminate the need to run multiple customer retention offer generators based upon the amount of customer data available. Thus, certain example embodiments discussed below are directed to improvements in computer-related technology.

Certain example embodiments described herein related to generating and analyzing customer retention offers using at least two predictive models.

In certain example embodiments, customer retention offers may be analyzed, generated, and managed using a plurality of models, with each model tailored to analyze data based upon the quantity of accumulated data for an individual customer.

In some example embodiments, a first predictive model may be configured to generate customer retention offers for customers with minimal usage data (i.e., newer accounts) that applies a logistic regression model to score customers. For example, the first predictive model may be used when usage data of a particular customer is below one or more thresholds, such as age of account, number of logins by the customer, and total amount of time using the service.

In various example embodiments, the first predictive model may use logistic regression to model the relationship between independent and dependent variables, wherein the dependent variables are binary.

As an example, a logistic regression model may include any statistical model that generates the probability of a certain input being associated with a category (e.g., true vs. false, active vs. inactive). The output of a logistic regression model may be a numerical value between 0 and 1, indicating the likelihood of the input being associated with the particular category. A logistic regression model may use a logistic (e.g., sigmoid) function in order to convert an output of a linear equation into the numerical value. For example, a sigmoid function may be defined as

$$σ ( z ) = \frac{1}{1 + {e}^{- z}} ,$$

where z may indicate a linear combination of inputs (e.g., z=w₁x₁+w₂x₂+ . . . +wₙxₙ+b), and e may be a constant. The output of the sigmoid function may be between 0 and 1.

Once sufficient data exists (i.e., at least the threshold amount of data), a second model may be configured to generate customer retention offers for customers with sufficient usage data. For example, the second predictive model may score customers using gradient boosting techniques, such as extreme gradient boosting (XGBoost) data modeling, which may sequentially generate multiple decision trees, wherein each decision tree is an improvement over previous trees. XGBoost data modeling may be performed in conjunction with a plurality of computer operating in parallel (e.g., Apache Hadoop, Oracle Sun Grid Engine (SGE), Message Passing Interface (MPI)).

In some example embodiments, the determination to transition from the first model to the second model may be time-based; for example, upon reaching a threshold age of a customer account, generation of customer retention offers may switch from the first model to the second model. As another example, a time-based determination may be made to transition from the second model to the first model, for example, based upon a period of inactivity/dormancy that the user has not used the service.

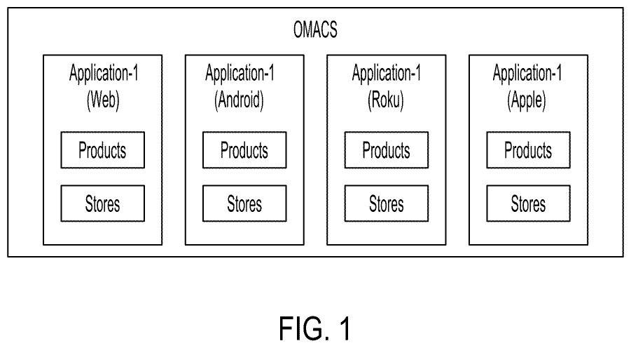

FIG. 1 illustrates an example OMACS having multiple parts. For example, each part may correspond to a different applications/streaming platforms (e.g., web, Google Android, Roku, Apple TV, YouTube, Netflix, Spotify). In addition, each part may be assigned dedicated pages, settings, products, and stores, of which users may select particular products and stores.

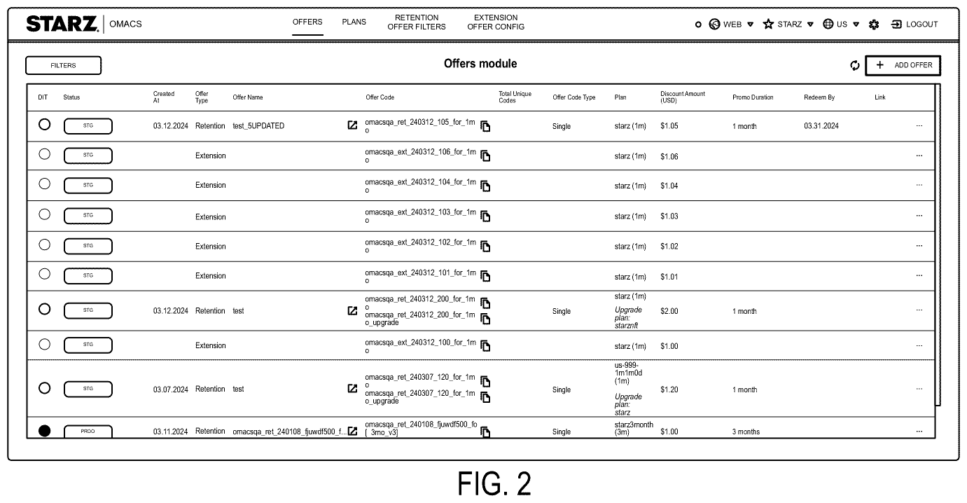

As shown in FIG. 2, offers may correspond with deals or incentives that are provided to the customer and the corresponding subscription. In various example embodiments, customer retention offers may include a variety of different categories of offers, such as:

Acquisition: attracts new users with a special deal. This may also be used to register a user for the first time. Customer acquisition cost (CAC) may describe the total cost of acquiring a new customer to a merchant, including marketing and onboarding. CAC may be calculated as

$$CAC = \frac{Total marketing and onboarding costs}{Number of Customers Acquired} .$$

It may be desirable to increase CLV while simultaneously reducing CAC.

Winback: attracts previous users that have completed the process of cancelling a subscription, and would subscribe again. This cost may be less than an acquisition cost, but similarly should be reduced, if not avoided by retaining customers in the first place. Winback cost may be calculated as

$$Winback cost = \frac{Total marketing and onboarding costs during winback efforts}{Number of customer won back} .$$

Reactivation: attracts users that have requested cancellation, but may still be in a final billing period. For example, if a user requests cancellation on the 12^{th} of the month, but is billed on the 15^{th} of the month, there will be a 3-day period for the user to reactivate their subscription.

Retention: deters users from leaving a subscription in order to cancel an active subscription.

Extension: similar to retention, but extends an active retention offer to deter users from cancelling an active subscription.

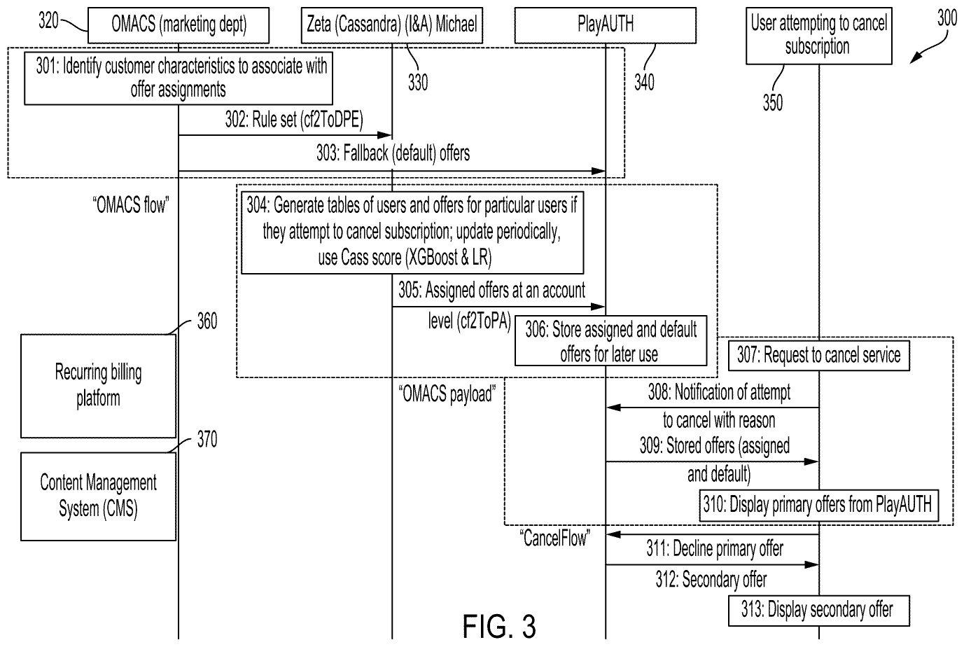

FIG. 3 illustrates an example of a signaling diagram 300 depicting techniques for generating, monitoring, and managing customer retention offers.

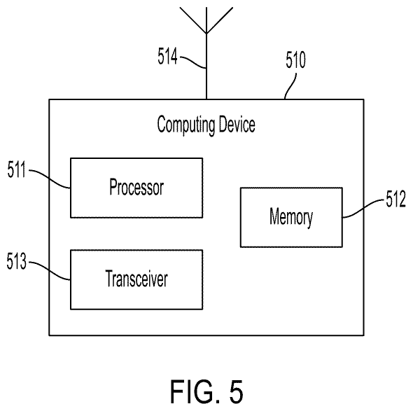

OMACS 320, Insights & Analytics (I&A) Management System (Zeta) 330, PlayAUTH 340, and User 350 may each be similar to computing device 510, as illustrated in FIG. 5, according to certain example embodiments. OMACS 320, Zeta 330, and PlayAUTH 340 may also be within the same device. OMACS 320 may also be associated with a recurring billing platform 360 and/or content management system (CMS) 370.

At operation 301, OMACS 320 may identify at least one customer characteristic to associate a customer with at least one offer assignment. For example, customer characteristics may include any number of demographics (e.g., age, gender, location, income, education level); content preferences (e.g., genre, original versus licensed, language); viewing habits (e.g., episodically, multiple episodes (i.e., “binge”); device (e.g., mobile, tabletop); viewing time (e.g., evening, weekends, holidays); and quality preferences (e.g., 4K, HD), among others.

At operation 302, OMACS 320 may transmit to Zeta 330 a rule set (e.g., cf2ToDPE). For example, the rule set may associate certain offers with at least one customer characteristic.

At operation 303, OMACS 320 may transmit to PlayAUTH 340 at least one fallback (i.e., default) offer. For example, fallback offers may be offers that may apply to any number of customers, regardless of their customer characteristics. Since they are not personalized nor targeted, fallback offers may be designed to minimize the discount provided to the customer, if ultimately offered to the customer.

At operation 304, Zeta 330 may generate a table of customers and offers corresponding for a particular customer. The offers may be used for customers that attempt to cancel a subscription.

In certain example embodiments, the table of offers may be updated periodically. For example, the table of offers may be updated according to a Cass score (e.g., XGBoost & LR). For example, a Cass score may be based on demographic data (e.g., provided by third-party data appends) that provides household profiles, particularly with respect to financial means. For example, customers with a higher Cass score may indicate greater disposable income (i.e., more money to spend on subscription services, and thus, less incentive needed), while a lower Cass score may indicate lower disposable income (i.e., less money to spend on subscription services, and thus, more incentive needed).

In various example embodiments, predictive models may use a variety of sources of data regardless of the modeling paradigm. Some examples may use both logistic regression (i.e., traditional model) and XGboost (i.e., machine learning, or AI, approach from data science) to build two models, both having access to multiple forms of customer data; the results may then be combined.

At operation 305, Zeta 330 may transmit to PlayAUTH 340 at least one assigned offer at an assigned account level (e.g., cf2ToPA). The assigned account level may be for a particular customer.

At operation 306, PlayAUTH 340 may store the assigned offers and fallback offers, and make them available for use when needed to be provided to user 350.

At operation 307, user 350 may submit a request to cancel a subscription service. For example, after logging into their account, user 350 may navigate to a subscription section, and select a “Cancel Subscription” option, which may require confirmation. Once confirmed, the request may be submitted to the subscription service. Simultaneously, at operation 308, user 350 may transmit to PlayAUTH 340 a notification of an attempt to cancel a subscription, which may include at least one reason for cancellation (e.g., no longer interested in content, service is too expensive, interface is confusing, etc.).

In response to the notification of an attempt to cancel a subscription, at operation 309, PlayAUTH 340 may transmit to user 350 at least one stored offer (e.g., assigned and default). For example, a user may attempt to cancel a subscription via a user account.

At operation 310, at least one of the stored offers received from PlayAUTH 340 may be displayed to user 350.

At operation 311, user 350 may transmit to PlayAUTH 340 an indication that user 350 has declined the offers displayed during operation 310.

At operation 312, PlayAUTH 340 may transmit to user 350 at least one secondary offer.

At operation 313, at least one of the secondary offers may be displayed to user 350.

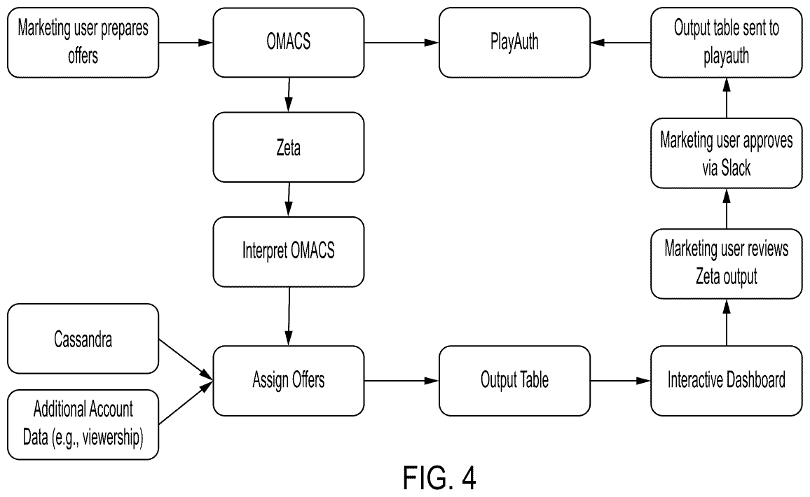

FIG. 4 illustrates an example of a system diagram. In general, a marketing team may prepare and upload a plurality of offers to a subscription subscriber to OMACS. OMACS may then communicate with Zeta to interpret the plurality of offers in OMACS. The plurality of offers may then be assigned, using data from Cass, and additional account information (e.g., viewership). An output table is then generated with the assigned offers, and displayed to a marketing user via an interactive dashboard. The marketing user may then review the output from Zeta (i.e., assigned offers in the output table), and provide an approval of the output (e.g., via Slack). The approved output table may then be uploaded to PlayAUTH for publication to a canceling user.

FIG. 5 illustrates an example of a system according to certain example embodiments. In one example embodiment, a system may include multiple devices, such as, for example, computing device 510.

Computing device 510 may include one or more of a mobile device, such as a smart television (TV), streaming stick (e.g., Roku, Fire TV stick, Apple TV), mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof. Furthermore, computing device 510 may be one or more of a citizens broadband radio service device (CBSD).

Computing device 510 may include at least one processor, respectively indicated as 511. Processor 511 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 512. The memory may be fixed or removable. The memory may include computer program instructions or computer code contained therein. Memory 512 may independently be any suitable storage device, such as a non-transitory computer-readable medium. The term “non-transitory,” as used herein, may correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processor 511, memory 512, and any subset thereof, may be configured to provide means corresponding to the various blocks of FIGS. 1-4. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like. As shown in FIG. 5, transceiver 513 may be provided, and one or more devices may also include at least one antenna, illustrated as 514.

The memory and the computer program instructions may be configured, with the processor for the particular device, to cause a hardware apparatus, such as UE, to perform any of the processes described above (i.e., FIGS. 1-4). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 1-4. As used in this application, the term “circuitry” may refer to one or more or all of the following: (a) hardware-only circuit implementations (such as implementations in only analog and/or digital circuitry), (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions), and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

According to certain example embodiments, processor 511 and memory 512 may be included in or may form a part of processing circuitry or control circuitry. In addition, in some example embodiments, transceiver 513 may be included in or may form a part of transceiving circuitry.

In some example embodiments, an apparatus (e.g., computing device 510) may include means for performing a method, a process, or any of the variants discussed herein. Examples of the means may include one or more processors, memory, controllers, transmitters, receivers, and/or computer program code for causing the performance of the operations.

In various example embodiments, apparatus 510 may be controlled by memory 512 and processor 511 to receive, from at least one application, customer data associated with at least one customer; determine that the customer data is below at least one threshold; perform a logistic regression on the customer data; receive additional customer data, wherein the customer data is at least the at least one threshold; perform a gradient boosting data modeling procedure on the additional customer data; and generate at least one customer retention offer.

Certain example embodiments may be directed to an apparatus that includes means for performing any of the methods described herein including, for example, means for receiving, from at least one application, customer data associated with at least one customer; means for determining that the customer data is below at least one threshold; means for performing a logistic regression on the customer data; means for receiving additional customer data, wherein the customer data is at least the at least one threshold; means for performing a gradient boosting data modeling procedure on the additional customer data; and means for generating at least one customer retention offer.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

As used herein, “at least one of the following: <a list of two or more elements>” and “at least one of <a list of two or more elements>” and similar wording, where the list of two or more elements are joined by “and” or “or,” mean at least any one of the elements, or at least any two or more of the elements, or at least all the elements.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

ASIC Application Specific Integrated Circuit
CAC Customer Acquisition Cost
CBSD Citizens Broadband Radio Service Device
CLV Customer Lifetime Value
CPU Central Processing Unit
GPS Global Positioning System
HDD Hard Disk Drive
I&A Insights & Analytics
IoT Internet of Things
LR Logistic Regression
MEMS Micro Electrical Mechanical System
MIMO Multiple Input Multiple Output
mMTC Massive Machine Type Communication
MPI Message Passing Interface
OMACS Offer Management System
PDA Personal Digital Assistance
RAM Random Access Memory
SGE Sun Grid Engine
ROM Read-Only Memory
WLAN Wireless Local Area Network
XGBoost Extreme Gradient Boosting

1. A method comprising:
receiving, by a computing device, from at least one application, customer data associated with at least one customer;
determining, by the computing device, that usage of the customer data is below at least one threshold, wherein the usage comprises at least one of age of account, number of logins by the at least one customer, and total amount of time using a service;
performing, by the computing device, a logistic regression on the customer data;
receiving, by the computing device, additional customer data, wherein usage of the additional customer data is at least the at least one threshold;
performing, by the computing device, a gradient boosting data modeling procedure on the additional customer data to transition from a first predictive model to a second predictive model for the at least one customer; and
generating, by the computing device, at least one customer retention offer.

2. The method of claim 1, wherein the logistic regression comprises modelling a relationship between at least one independent variable and at least one dependent variable of a first predictive model.

3. The method of claim 1, wherein the logistic regression comprises at least one statistical model configured to generate a probability of a certain input being associated with a category.

4. The method of claim 1, wherein an output of the logistic regression indicates a likelihood of an input being associated with a particular category.

5. The method of claim 1, wherein the gradient boosting data modeling comprises sequentially generating multiple decision trees according to a second predictive model.

6. The method of claim 1, further comprising:
transmitting the at least one customer retention offer to a user device for display.

7. The method of claim 1, further comprising:
receiving, by the computing device, at least one response to the at least one displayed customer retention offer.

8. An apparatus comprising:
at least one processor; and
at least one memory storing instructions that, when executed by the at least one processor, cause the apparatus at least to:
receive, from at least one application, customer data associated with at least one customer;
determine that usage of the customer data is below at least one threshold, wherein the usage comprises at least one of age of account, number of logins by the at least one customer, and total amount of time using a service;
perform a logistic regression on the customer data;
receive additional customer data, wherein usage of the additional customer data is at least the at least one threshold;
perform a gradient boosting data modeling procedure on the additional customer data to transition from a first predictive model to a second predictive model for the at least one customer; and
generate at least one customer retention offer.

9. The apparatus of claim 8, wherein the logistic regression comprises modelling a relationship between at least one independent variable and at least one dependent variable of a first predictive model.

10. The apparatus of claim 8, wherein the logistic regression comprises at least one statistical model configured to generate a probability of a certain input being associated with a category.

11. The apparatus of claim 8, wherein an output of the logistic regression indicates a likelihood of an input being associated with a particular category.

12. The apparatus of claim 8, wherein the gradient boosting data modeling comprises sequentially generating multiple decision trees according to a second predictive model.

13. The apparatus of claim 8, wherein the at least one memory storing the instructions, when executed by the at least one processor, further cause the apparatus at least to:
transmit the at least one customer retention offer to a user device for display.

14. The apparatus of claim 8, wherein the at least one memory storing the instructions, when executed by the at least one processor, further cause the apparatus at least to:
receive at least one response to the at least one displayed customer retention offer.

15. A non-transitory computer readable medium comprising program instructions stored thereon for causing an apparatus to perform at least the following:
receive, from at least one application, customer data associated with at least one customer;
determine that usage of the customer data is below at least one threshold, wherein the usage comprises at least one of age of account, number of logins by the at least one customer, and total amount of time using a service;
perform a logistic regression on the customer data;
receive additional customer data, wherein usage of the additional customer data is at least the at least one threshold;
perform a gradient boosting data to transition from a first predictive model to a second predictive model for the at least one customer modeling procedure on the additional customer data; and
generate at least one customer retention offer.

16. The non-transitory computer readable medium of claim 15, wherein the logistic regression comprises modelling a relationship between at least one independent variable and at least one dependent variable of a first predictive model.

17. The non-transitory computer readable medium of claim 15, wherein the logistic regression comprises at least one statistical model configured to generate a probability of a certain input being associated with a category.

18. The non-transitory computer readable medium of claim 15, wherein an output of the logistic regression indicates a likelihood of an input being associated with a particular category.

19. The non-transitory computer readable medium of claim 15, wherein the gradient boosting data modeling comprises sequentially generating multiple decision trees according to a second predictive model.

20. The non-transitory computer readable medium of claim 15, wherein the program instructions are further configured to cause the apparatus to perform at least the following:
transmit the at least one customer retention offer to a user device for display.
